(19) United States
(12) Patent Application Publication
(10) Pub. No.: US 2021/0374865 A1
(43) Pub. Date: Dec. 2, 2021

(54) Method and System for Equitably Allocating a Financial Distribution to Multiple Investors

(71) Applicants: David BOYDELL, Sonoma, CA (US); Jeremy ROSEBERRY, Delray Beach, FL (US); BATTLELINE TECHNOLOGIES, LLC, Delray Beach, FL (US)

(72) Inventors: David Boydell, Sonoma, CA (US); Jeremy Roseberry, Delray Beach, FL (US)

(73) Assignee: FairShares, Inc,, Delray Beach, FL (US)

(21) Appl. No.: 17/052,772

(22) PCT Filed: Jul. 5, 2019
(86) PCT No.: PCT/US19/40738

§ 371 Date: Nov. 3, 2020

Related U.S. Application Data
(60) Provisional application No. 62/694,363, filed on Jul. 5, 2018.
(60) Provisional application No. 62/787,563, filed on Jan. 2, 2019.
(60) Provisional application No. 62/854,886, filed on May 30, 2019.

(51) Int. Cl. G06Q 40/06; G06Q 20/02; G06Q 40/02; G06F 16/2455

(52) U.S. Cl. CPC G06Q 40/06; G06F 16/24556; G06Q 40/02; G06Q 20/02

(57) ABSTRACT

A system includes: a security issuer; a payment agent operably connected to the security issuer, the payment agent configured to instruct the security issuer to send the total distribution for a payment period comprising a plurality of intervals; a bank operably connected to the payment agent, the bank configured to receive the total distribution from the security issuer; and an investor operably connected to the payment agent, the investor operably connected to the bank, the payment agent further configured to compute an individual distribution equitably allocating a portion of the total distribution to an investor who owns the security at the end of at least one of the intervals, thereby computing the individual distribution payable to the investor, the payment agent further configured to instruct the bank to send the individual distribution to the investor, the payment agent further configured to verify that the bank has paid the individual distribution to the investor.

PRIORITY CLAIM

The present application claims the priority benefit of U.S. provisional patent application No. 62/694,363 filed Jul. 5, 2018 and entitled “Method and System for Equitably Allocating Financial Distributions,” of U.S. provisional patent application No. 62/787,563 filed Jan. 2, 2019 and entitled “Investment Fund for Equitably Allocating Financial Distributions,” and of U.S. provisional patent application No. 62/854,886 filed May 30, 2019 and entitled “System and Method for Removing a Distribution from a Value of a Security,” the disclosures of which are incorporated herein by reference.

### CROSS-REFERENCE TO RELATED APPLICATIONS

This application contains subject matter that is related to the subject matter of the following applications, which are assigned to the same assignee as this application. The below-listed applications are hereby incorporated by reference in their entirety, apart from the limitations mentioned in this paragraph. Any incorporation by reference of documents below is limited such that no subject matter is incorporated that is contrary to the explicit disclosure herein. Any incorporation by reference of documents below is further limited such that no claims included in the documents are incorporated by reference herein. Any incorporation by reference of documents above is yet further limited such that any definitions, disavowals; disclaimers, and claims provided in the documents are not incorporated by reference herein unless expressly included herein:

“METHOD AND SYSTEM FOR EQUITABLY ALLOCATING A FINANCIAL DISTRIBUTION TO MULTIPLE INVESTORS,” by Boydell and Roseberry, co-filed herewith.

“SINGLE-SECURITY FUND FOR EQUITABLY ALLOCATING A FINANCIAL DISTRIBUTION TO MULTIPLE INVESTORS,” by Boydell and Roseberry, co-filed herewith.

“METHOD AND SYSTEM FOR ESTIMATING ACCRUED, EQUITABLY ALLOCATED DISTRIBUTION INCOME FROM A SECURITY,” by Boydell and Roseberry, co-filed herewith.

### SUMMARY

Embodiments of the invention relate in general to a method and system for equitably allocating a financial distribution to multiple investors using a payment agent. Other embodiments of the invention relate to a method and system for equitably allocating a financial distribution to multiple investors using a payment agent, the method and system configured to equitably allocate financial distributions based on one or more of a time of securities owned, a quantity of securities owned, security ownership information, location at which the security is held, an account number, and the like.

A system for equitably allocating a total distribution by a security to multiple investors, comprising: an issuer of a security, the issuer configured to issue the total distribution of the security; a payment agent operably connected to the security issuer, the payment agent configured to instruct the security issuer to send the total distribution for a payment period comprising a plurality of intervals; a bank operably connected to the payment agent, the bank configured to receive the total distribution from the security issuer; and an investor operably connected to the payment agent, the investor operably connected to the bank, the payment agent further configured to receive data regarding one or more of a position of the investor in the security at an end of and a length of the interval, the payment agent further configured to aggregate the data, the payment agent further configured to determine if data is missing that the payment agent needs to compute the equitable allocation of the total distribution, the payment agent further configured to request that missing data needed to compute the equitable allocation be provided to the payment agent, the payment agent further configured to determine that the aggregated data needed to compute the equitable allocation has arrived to the payment agent, thereby concluding a data aggregation period, the payment agent further configured to compute an individual distribution equitably allocating a portion of the total distribution to an investor who owns the security at the end of at least one of the intervals, thereby computing the individual distribution payable to the investor, wherein computing, by the payment agent comprises equitably allocating a portion of the total distribution to an investor who owns the security at the end of at least one of the intervals, wherein computing comprises calculating, for each investor in the security during the payment period, a sum over the payment period of share-intervals for the investor, wherein computing further comprises dividing the sum of share-intervals for the investor by a sum of share-intervals for all investors, during the payment period, and then multiplying by the total distribution, where a share-interval comprises a product of a length of the interval at the end of which the investor owned the security and shares of the security owned by the investor at the end of the interval, the payment agent further configured to instruct the bank to send the individual distribution to the investor.

### DESCRIPTION OF THE DRAWINGS

The accompanying drawings provide visual representations which will be used to more fully describe various representative embodiments and can be used by those skilled in the art to better understand the representative embodiments disclosed herein and their inherent advantages. In these drawings, like reference numerals identify corresponding elements.

FIG. 1 is a block diagram of a system for equitably allocating a financial distribution to multiple investors using a payment agent.

### DETAILED DESCRIPTION

Embodiments of the invention relate in general to a method and system for equitably allocating a financial distribution to multiple investors using a payment agent.

A security comprises a financial instrument available for acquisition by an investor hoping for a financial return on the investment. For example, a security comprises one or more of a note, a common stock, a preferred stock, a security future, a security-based swap, a bond, a debenture, evidence of indebtedness, a certificate of interest in a profit-sharing agreement, a certificate of participation in a profit-sharing agreement, a collateral-trust certificate, a preorganization certificate, a preorganization subscription, a transferable share, an investment contract, a voting-trust certificate, a certificate of deposit for a security, a fractional undivided interest in one or more of a mineral right, a put on a security, a call on a security, a straddle on a security, an option on a security, a privilege on a security, a certificate of deposit, a group of securities (including any interest therein or based on the value thereof), an index of securities (including any interest therein or based on the value thereof), a put on a foreign currency, a call on a foreign currency, a straddle on a foreign currency, an option on a foreign currency, a privilege entered into on a national securities exchange relating to a foreign currency, another interest or instrument commonly known as a security, an investment contract involving a blockchain, a security token, a smart contract, a distributed ledger system, a digital interest in a contract that has the potential to generate a distribution, a real estate investment trust (REIT), a limited partnership interest, a special purpose entity, a master limited partnership (MLP), a closed-ended mutual fund, an open-ended ended mutual fund, an American depository receipt (ADR), an asset backed-security, a mortgage-backed security, a collateralized mortgage obligation, an exchange-traded fund, a money market instrument, a municipal bond, a municipal variable-rate demand obligation, a private placement, a sovereign debt, a unit investment trust, a certificate of one or more of interest in an investment company and participation in an investment company, an investment fund; a pooled investment vehicle, an exchange-traded fund, a mutual fund, and another security. For example, the mineral right comprises a right to one or more of gas, oil, and another mineral.

A security further comprises one or more of a temporary certificate for, an interim certificate for, a receipt for, a guarantee of, a warrant to subscribe to, and a right to do one or more of subscribe to and purchase a security. Embodiments of the invention can be applied to any income-producing security.

A financial distribution (“distribution”) can be defined as one or more of a cash dividend, an interest payment, a principal, a short-term capital gain, a long-term capital gain, a sale of a right relating to an American Depository Receipt (ADR) security, a return of capital, a dividend with an option, a stock split, a stock, an automatic dividend reinvestment, a spinoff, a distribution of rights, an in-kind payment, a liquidation, a tax event, and another financial distribution. The stock dividend comprises one or more of an ordinary stock dividend, a preferred stock dividend, a special stock dividend, and a common stock dividend. For example, the dividend comprises one or more of a dividend in a privately traded stock and another stock dividend. The dividend reinvestment comprises one of more of an ordinary dividend reinvestment, and an increase of shares of stock. The cash dividend comprises one or more of an ordinary cash dividend, relief from payment of a foreign tax, a reclamation of tax, a special dividend, a voluntary dividend reinvestment and another cash dividend. For example, the voluntary dividend reinvestment comprises an increase in a number of shares owned of a security that generated the dividend.

For purposes of this application, a “total distribution” is a distribution paid by a security to investors in a security during a payment period. The payment period is the time period over which a distribution amount is calculated for payment to an investor. For example, a total distribution is a distribution paid by a security to all investors in the security during the payment period. The payment period is the time period over which a distribution amount is calculated for payment to an investor. For purposes of this application, an “individual distribution” is a distribution paid by the security to an investor in the security during the payment period. For example, the payment period comprises one or more of a month, a quarter, a half-year, a year, and another payment period.

For purposes of this application, a share comprises an ownership unit of a security. For example, a share comprises one or more of a share of a stock, a number of bonds owned, and another ownership unit of another security.

For purposes of this application, a payment agent comprises an entity configured to do one or more of receive the distribution from the security issuer, compute an equitable allocation of the distribution to at least one investor who owns the security during at least part of a payment period, and pay the equitably allocated distribution to the investor.

Preferably, but not necessarily, the payment agent comprises an entity configured to receive the distribution from the security issuer, further configured to receive data regarding a position of the investor in the security at an end of an interval and data regarding the length of the interval, further configured to compute an equitable allocation of the distribution to at least one investor who owns the security during at least part of a payment period, and further configured to instruct the bank to pay the equitably allocated distribution to the investor.

For example, the interval comprises one or more of an hour, a day, two days, three days, and seven days. For example, the interval comprises one weekday. For example, the interval comprises a two-day weekend. For example, the interval comprises a three-day weekend.

Alternatively, or additionally, the payment agent does not receive the distribution, nor does the payment agent pay the equitably allocated distribution to the investor. According to these embodiments, the payment agent still receives the data regarding one or more of the position of the investor in the security and the length of the interval, and the payment agent computes the equitably allocated distribution using the data regarding a position of the investor in the security at an end of an interval and using the data regarding the length of the interval. For example, the payment agent then provides the calculations of the equitably allocated distribution to a payor.

Equitable Distribution Method Usable by Payment Agent

Embodiments of the invention comprise a method for equitably allocating a financial distribution to multiple investors using a payment agent. For example, the method accounts for one or more of an interval for which the security is owned and a potentially varying quantity of securities held over one or more intervals in the payment period.

For example, a method and system is provided to use the payment agent to equitably allocate income earned by the security to an investor in the security. For example, as part of computing the equitable allocation, the system adds up share-intervals, which are defined as products of a number of shares held at the end of an interval in the payment period times a length of the interval:

share-interval=[(number of shares held at the end of the interval)*(length of interval for which the shares are held)]

For purposes of this application, an individual distribution is defined as equitable when the distribution is equal to the sum of share-intervals in the security during the payment period divided by the sum of all investors' share-intervals in the security during the payment period, and multiplied by the total distribution.

For example, using the data, the payment agent computes share-intervals for all investors. Alternatively, or additionally, the payment agent receives from an external source a computation of share-intervals for one or more investors from an external source. For example, the payment agent receives from the external source a computation of a sum of share-intervals for one or more investors. For example, the payment agent is further configured to compute the share-intervals on a continual basis.

For example, the payment agent is further configured to aggregate the data. For example, the payment agent is further configured to compute the share-intervals at the end of the data aggregation period.

The payment agent calculates the individual distribution payable to the investor as equal to the sum over a payment period of share-intervals for the investor, divided by a sum of share-intervals for all investors, during the payment period, and then multiplied by the total distribution.

One way to look at this example is that for the payment period, the system essentially computes a “time-weighted total” of the number of shares held by a given investor, divided by a “time-weighted total” of the number of shares held by all investors, and multiplied by the total distribution payable during that payment period.

For example, using the data, the payment agent computes share-intervals for all investors. Alternatively, or additionally, the payment agent receives a computation of share-intervals for one or more investors from an external source.

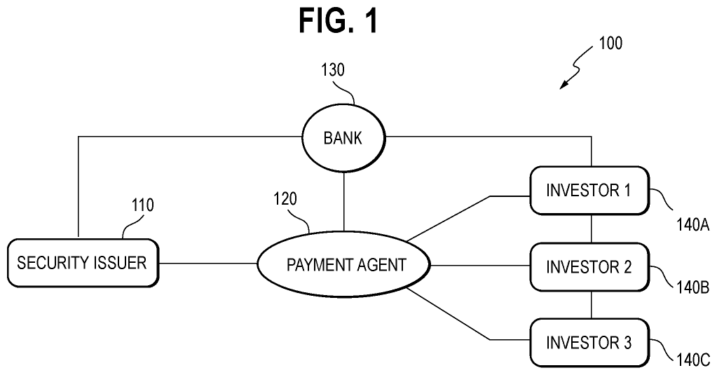

FIG. 1 is a block diagram of a system 100 for equitably allocating a financial distribution. The system 100 comprises a security issuer 110, a payment agent 120 operably connected to the security issuer 110, a bank 130 operably connected to the payment agent 120, and investors 140A, 140B, 140C operably connected to the payment agent 120, the investors 140A, 140B, 140C also each operably connected to the bank 130.

For example, the security issuer 110 comprises one or more of an investment fund, an entity that has issued a stock, an entity that has issued a bond, and another security issuer. The payment agent 120 is configured to receive from the security issuer 110 a declaration that a total distribution will be issued by the security issuer. The payment agent may be further configured to request that missing data needed to compute the equitable allocation be provided to the payment agent. The payment agent may be further configured to determine if data is missing that the payment agent needs to compute the equitable allocation of the total distribution.

The payment agent 120 is further configured to aggregate security ownership data using records that the security issuer receives from a data source. Typically, although not necessarily, the payment agent 120 aggregates security ownership data received from a plurality of data sources. For example, the data source comprises one or more of the Depository Trust Company (DTC), a transfer agent, a custodian, a broker-dealer, and another data source.

The security issuer 110 is configured to send distributions to the bank 130 on behalf of the payment agent 120, the distributions ultimately to be equitably allocated by the payment agent 120 using the system 100 for equitably allocating financial distributions to the investors 140A, 140B, 140C. The security issuer 110 sends a total distribution for a payment period to the bank 130 on behalf of the payment agent 120. For example, the security issuer 110 sends total distributions to the bank 130 on behalf of the payment agent 120 one or more of nightly, weekly, monthly, quarterly, at an end of the payment period, prior to the end of the payment period, and after the end of the payment period.

The bank 130 is configured to retain the total distributions received from the security issuer 110. The payment agent 120 is further configured to compute an individual distribution due to an individual investor for the payment period using the system 100 and method for equitably allocating a financial distribution. The payment agent 120 is further configured to instruct the security issuer 110 to send the total distribution to the bank 130. For example, the payment agent 120 is further configured to instruct the security issuer 110 to send the total distribution to the bank 130 for holding until the payment agent 120 calculates the equitable allocation of financial distributions, at which point the payment agent 120 instructs the bank 130 to send the total distribution to the investors 140A, 140B, 140C. Alternatively, or additionally, the payment agent 120 calculates the equitable allocations of financial distributions to the investors 140A, 140B, 140C after the payment agent determines that aggregated data needed to compute the equitable allocation has arrived to the payment agent, thereby concluding a data aggregation period. For example, data aggregation comprises determining if needed data has arrived to the payment agent or, alternatively, if data is missing that the payment agent needs to compute the equitable allocation of the total distribution.

For example, the data aggregation period can be nearly zero, that is, the conclusion of data aggregation can coincide with the computation of the equitable allocation. For example, the data aggregation period can be approximately ninety days. For example, the data aggregation period can be approximately 180 days. For example, the data aggregation period can comprise a time period between approximately zero up to approximately one year.

The payment agent 120 instructs the bank 130 to pay the equitably allocated individual distribution to the investors 140A, 140B, 140C. Alternatively, or additionally, the bank 130 pays the investors 140A, 140B, 140C via one or more intermediaries (not shown). The payment agent 120 subsequently verifies that the payments were made properly. For example, the payment agent 120 verifies the payments were made by communicating with the bank 130. For example, the payment agent 120 verifies the payments were made by communicating to the investors 140A, 140B, 140C via one of more of their respective custodians (not shown) and their respective broker-dealers (not shown).

For example, an intermediary comprises a custodian. The custodian is configured to hold the securities on behalf of the investor. The custodian is further configured to receive the equitably allocated individual distributions from the payment agent 120. The custodian is further configured to hold the equitably allocated individual distributions until the custodian receives instructions to send the equitably allocated individual distributions to one or more of the investors 140A, 140B, 140C and a broker-dealer (not shown).

The broker-dealer is configured to receive a request to purchase or sell a security from the investors 140A, 140B, 140C. The broker-dealer is further configured to process the trade on behalf of the investors 140A, 140B, 140C. The broker-dealer is further configured to send the equitably allocated individual distributions to the investors 140A, 140B, 140C.

Optionally, the payment agent 120 comprises the bank 130. Optionally, the security issuer 110 acts as its own payment agent 120. That is, optionally, the security issuer 110 comprises the payment agent 120. For example, the security issuer 110 comprises one or more of an issuer of a bond, an issuer of a stock, and an investment fund.

According to embodiments of the invention, the payment agent 120 receives transaction data regarding how many securities the investors 140A, 140B, 140C own at an end of a given interval comprised in the payment period. For example, the interval comprises one or more of an hour, a day, seven days, a week, and a month.

Using Payment Agent to Remove Distributions From the Net Asset Value (NAV) of an Investment Fund

According to a method of removing the distributions from the Net Asset Value (NAV) of an investment fund, which is discussed more fully in the patent application “INVESTMENT FUND FOR EQUITABLY ALLOCATING A FINANCIAL DISTRIBUTION TO MULTIPLE INVESTORS,” by Boydell and Roseberry, co-filed herewith, a distribution payable to the investment fund's investors is recorded as a payable liability, withdrawn from the investment fund and transmitted to the bank on behalf of the payment agent. The bank holds the distribution until the payment agent instructs the bank to distribute the distribution to a holder of the security. For example, the distribution is withdrawn from the investment fund and sent to the bank on a regular basis. For example, the distribution is withdrawn from the NAV and sent to the bank on an irregular basis.

The payment agent accumulates distributions over the entire payment period. Then, according to further embodiments of the invention, when the investment fund declares its distribution, the payment agent requests data for the payment period showing, for each interval, one or more of a number of shares that each investor in the investment fund owned at an end of that interval and a length of the interval.

The payment agent processes the data, using an equitable distribution method according to embodiments of the invention, and determines the distribution that each investor will receive. The payment agent then makes appropriate payments to each individual investor's account. For example, the payment agent makes payments using a custodian or institution authorized to receive payments on behalf of the investor. Alternatively, or additionally, the payment agent makes payments directly to the investor.

According to a second method of removing the distributions from the NAV of an investment fund, with the investment fund acting as its own bank, the investment fund uses an internal accounting method to segregate the distributions from the NAV by accounting for them as a liability. According to embodiments of the invention, when the investment fund declares its distribution for a payment period, the payment agent computes an equitable allocation of the distribution. The payment agent instructs the investment fund how to equitably allocate the distribution to a holder of the security. Using the instructions from the payment agent, the investment fund makes payments to an investor in the investment fund for the payment period using the inventive equitable distribution method. For example, the investment fund makes payments to each investor in the investment fund for the payment period using the inventive equitable distribution method.

Embodiments of the invention use a decentralized ledger system to do one or more of a record a transaction and verify ownership of a security. For example, the decentralized ledger system comprises blockchain technology. For example, the decentralized ledger system comprises another decentralized ledger system other than blockchain technology. For example, according to embodiments of the invention, a recordkeeping system analyzes time stamps and a quantity of securities on a block representing a transaction in a blockchain to determine one or more of shares held by an investor at an end of an interval and length of the interval. For example, according to embodiments of the invention, a recordkeeping system analyzes time stamps and a quantity of securities on each block representing a transaction in a blockchain. Using the analysis of the time stamps, the system determines how income is equitably allocated to at least one owner of the security based on one or more of a time for which the owner owned the security and a quantity of securities owned. For example, the ownership tracking is performed using one or more of a digital time stamp and another ownership tracking system.

The calculations for the method can be performed using an electronic record-keeping system that will measure one or more of a unit of time for which a security is owned and a quantity of the security owned for a unit of time.

According to further embodiments of the invention, an electronic record keeping method and system is provided. The electronic record keeping method and system is configured to keep track of, and to equitably allocate, financial distribution events upon a transfer of a security from a first party to a second party. Embodiments of the invention compute equitable financial distributions for holders of a security or investment contract during the payment period. For example, embodiments of the invention compute equitable financial distributions for holders of a security or investment contract during the payment period. The distribution can be calculated based on a digital time stamp created upon the transfer of a security from one party to another. For example, the distribution can be calculated based on a quantity of securities owned by an investor and a digital time stamp created for each interval at the end of which the investor owned the security. The distribution can also be calculated by using an electronic record keeping system/database that is designed to track and account for a length of a time interval and the quantity of securities owned by each investor at the end of the time interval. The digital time stamp or electronic record keeping system comprises information regarding one or more of a time of securities owned, a quantity of securities owned, security ownership information, location at which the security is held, an account number, and the like. According to other embodiments of the invention, anticipated or actual distributions can be accrued as payable liabilities.

According to further embodiments of the invention, the distributions are classified by their type for tax purposes. For example, the distributions are classified as one or more of interest, a short-term capital gain, a long-term capital gain, a dividend, a qualified dividend, an ordinary dividend, and another distribution classification. For example, the equitable distribution amount is calculated based on one or more of a quantity of the security and a time for which the security is held.

According to additional embodiments of the invention, the electronic recordkeeping method and system is configured to track ownership of a security. The system calculates an equitable allocation using a digital time stamp the system creates upon a transfer of a security from a first party to a second party.

An advantage of embodiments of the invention is enabling distribution payments to be accounted for more accurately by accruing distributions owed to investors as payable liabilities. An advantage of embodiments of the invention is elimination of a need to pay the accumulated interest when purchasing a fixed income instrument, thereby promoting one or more of better investment returns and a more efficient market.

An additional advantage of embodiments of the invention is that due to the discounted price of the security, an investor can buy more shares and achieve higher before and after tax investment returns. An additional advantage of embodiments of the invention is that the investor can avoid one or more of volatility and capital losses associated with drops in the individual security prices associated with distributions.

An advantage of embodiments of the invention is that all investors during a payment period who own securities for any length of time receive an individual distribution, unlike the current system in which only the investor holding the security on the last day of the payment period receives the entire distribution and the other investors receive nothing. A further advantage of embodiments of the invention is that the currently mandated drop in the securities price on the ex-dividend date will not be necessary since the price of the security will be valued without the distribution premium. An additional advantage of embodiments of the invention is eliminating a potential for investors to game the system by purchasing a security immediately in advance of the ex-dividend date and selling the security on or immediately after the ex-dividend date. A still further advantage of embodiments of the invention is providing prices of securities that are more accurate. A yet other advantage of embodiments of the invention is providing prices of securities that are more beneficial to investors.

Further advantages of embodiments of the invention include ensuring that an investor is paid from the moment the investor buys an income-producing security until the moment the investor sells the income-producing security. A further advantage of embodiments of the invention is enabling an investor holding a fund that comprises another fund to avoid paying multiple distribution premiums at each security level. An additional advantage of embodiments of the invention is thereby preventing an investor from paying substantially more than a value of the underlying investments.

Another advantage of embodiments of the invention is that a frequency of distributions can be changed.

A still further advantage of embodiments of the invention is more equitable allocation of earnings, interest and other distributions. Another advantage is preventing taxation of individuals for transactions to which they were not a principal party. Another advantage of embodiments of the invention is that investors in funds that distribute capital gains will only be responsible for their pro rata share of gains. Another advantage of embodiments of the invention is that the embodiments of the invention are well suited for one or more of an investor planning on holding the security for less than a year, and an investment manager planning on holding the stock for less than a year.

Additional advantages of embodiments of the invention include: 1) Purchasing a security pursuant to embodiments of the invention improves investment return relative to a prior art security. 2) Purchasing a security pursuant to embodiments of the invention also improves an investor's buying power relative to one or more of a prior art security. Therefore, investors can accumulate more shares relative to shares of a prior art security. 3) Purchasing a security pursuant to the embodiments of the invention lowers volatility of the security, which increases its risk-adjusted returns. 4) Purchasing a security according to embodiments of the invention allows an investor to realize more gains as qualified income rather than ordinary income, which is taxed up to twice as much. 5) Purchasing an investment fund or single security pursuant to the embodiments of the invention allows the investor to avoid paying the added cost of the embedded distributions or interest when they buy the security as well as avoiding paying increased investment management fees because of the inflated value of the security.

A further advantage of embodiments of the invention is avoiding illogical outcomes in which an investor who owns a fund for 11 months does not incur a taxable event related to the distribution of short- and long-term gains and an investor who buys the fund 15 days before the ex-dividend date is burdened with the entire year's taxable distributions.

A still further advantage of embodiments of the invention is elimination of current accounting treatment that inflates the value of security beyond its fair value and forces investors to pay a premium for the security. The distribution premium increases investment management fees investors pay to own the security and decreases the number of securities an investor can purchase.

An additional advantage of embodiments of the invention is that an investment fund's tracking error will be reduced.

For example, it will be understood by those skilled in the art that software used by the method and system for equitably allocating a financial distribution may be located in any location in which it may be accessed by the device. It will be further understood by those of skill in the art that the number of variations of the method and device are virtually limitless. It is intended, therefore, that the subject matter in the above description shall be interpreted as illustrative and shall not be interpreted in a limiting sense. For example, interconnections of the different components in the system diagram, FIG. 1, can differ while still operating pursuant to and consistently with the invention.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain steps and certain components can be altered without substantially impairing the functioning of the invention.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the invention. It is intended, therefore, that the subject matter in the above description shall be interpreted as illustrative and shall not be interpreted in a limiting sense.

What is claimed is:

1. A system for equitably allocating a total distribution by a security to multiple investors, comprising:
an issuer of a security, the issuer configured to issue the total distribution of the security;
a payment agent operably connected to the security issuer, the payment agent configured to receive from the security issuer a declaration that the total distribution will be issued by the security issuer;
instruct the security issuer to send the total distribution for a payment period comprising a plurality of intervals;
a bank operably connected to the payment agent, the bank configured to receive the total distribution from the security issuer; and
an investor operably connected to the payment agent, the investor operably connected to the bank, the payment agent further configured to compute an individual distribution equitably allocating a portion of the total distribution to an investor who owns the security at an end of at least one of the intervals, thereby computing the individual distribution payable to the investor, wherein an investor's percentage of the total distribution is proportional to a level of investment of the investor, the payment agent further configured to instruct the bank to send the individual distribution to the investor, the payment agent further configured to verify that the bank has paid the individual distribution to the investor.

2. The system of claim 1, wherein the payment agent is further configured to receive data regarding one or more of a position of the investor in the security at the end of and a length of the interval.

3. The system of claim 2, wherein the payment agent is further configured to aggregate the data.

4. The system of claim 3, wherein the payment agent is further configured to determine if data is missing that the payment agent needs to compute the equitable allocation of the total distribution.

5. The system of claim 3, wherein the payment agent is further configured to request that missing data needed to compute the equitable allocation be provided to the payment agent.

6. The system of claim 3, wherein the payment agent is further configured to determine that the aggregated data needed to compute the equitable allocation has arrived to the payment agent, thereby concluding a data aggregation period.

7. The system of claim 6, wherein the payment agent is further configured to compute a sum over a payment period of share-intervals for the investor, where a share-interval comprises a product of a length of the interval at the end of which the investor owned the security and shares of the security owned by the investor at the end of the interval.

8. The system of claim 7, wherein the payment agent is further configured to compute the individual distribution payable to the investor as equal to the sum over a payment period of share-intervals for the investor, divided by a sum of share-intervals for all investors during the payment period, multiplied by the total distribution.

9. The system of claim 1, wherein the payment agent is further configured to compute the individual distribution payable to each investor in the security during the payment period.

10. The system of claim 1, wherein the payment agent is further configured to verify that the bank has paid the individual distribution to the investor by communicating with the bank.

11. The system of claim 7, wherein the payment agent is further configured to compute the share-intervals on a continual basis.

12. The system of claim 7, wherein the payment agent is further configured to compute the share-intervals at the end of the data aggregation period.

13. A system for equitably allocating a total distribution by a security to multiple investors, comprising:
an issuer of a security, the issuer configured to issue the total distribution of the security;
a payment agent operably connected to the security issuer, the payment agent configured to instruct the security issuer to send the total distribution for a payment period comprising a plurality of intervals;
a bank operably connected to the payment agent, the bank configured to receive the total distribution from the security issuer; and
an investor operably connected to the payment agent, the investor operably connected to the bank, the payment agent further configured to receive data regarding one or more of a position of the investor in the security at an end of and a length of the interval, the payment agent further configured to aggregate the data, the payment agent further configured to determine if data is missing that the payment agent needs to compute the equitable allocation of the total distribution, the payment agent further configured to request that missing data needed to compute the equitable allocation be provided to the payment agent, the payment agent further configured to determine that the aggregated data needed to compute the equitable allocation has arrived to the payment agent, thereby concluding a data aggregation period, the payment agent further configured to compute an individual distribution equitably allocating a portion of the total distribution to an investor who owns the security at the end of at least one of the intervals, thereby computing the individual distribution payable to the investor, wherein an investor's percentage of the total distribution is proportional to a level of investment of the investor, wherein computing, by the payment agent comprises equitably allocating a portion of the total distribution to an investor who owns the security at the end of at least one of the intervals, wherein computing comprises calculating, for each investor in the security during the payment period, a sum over the payment period of share-intervals for the investor, wherein computing further comprises dividing the sum of share-intervals for the investor by a sum of share-intervals for all investors, during the payment period, and then multiplying by the total distribution, where a share-interval comprises a product of a length of the interval at the end of which the investor owned the security and shares of the security owned by the investor at the end of, the payment agent further configured to instruct the bank to send the individual distribution to the investor.
